(19) United States
(12) Patent Application Publication
(10) Pub. No.: US 2015/0154348 A1
(43) Pub. Date: Jun. 4, 2015

(54) METHOD AND APPARATUS FOR ANALYZING GENETIC DATA

(71) Applicant: Samsung Electronics Co., Ltd., Suwon-si (KR)

(72) Inventors: Daesoon Son, Seoul (KR); Taejin Ahn, Seoul (KR); Eunjin Lee, Seongnam-si (KR); Jongsuk Chung, Hwaseong-si (KR)

(21) Appl. No.: 14/521,028

(22) Filed: Oct. 22, 2014

(30) Foreign Application Priority Data
Dec. 2, 2013 (KR) 10-2013-0148452

(51) Int. Cl. G06F 19/18

(52) U.S. Cl. CPC G06F 19/18

(57) ABSTRACT

A method and apparatus for analyzing genetic data of a subject generates a plurality of bootstrap data sets having binary response variables related to a specific response from the genetic data; determines a first bootstrap data set that represents the bootstrap data sets, based on distributions of the binary response variables; generates permutation null distributions by permutating the first bootstrap data set P (where P is a natural number) times; and calculates an empirical power of the bootstrap data sets by testing respective levels of significance of the bootstrap data sets based on the permutation null distributions.

### RELATED APPLICATION

This application claims the benefit of Korean Patent Application No. 10-2013-0148452, filed on Dec. 2, 2013, in the Korean Intellectual Property Office, the disclosure of which is incorporated herein in its entirety by reference.

### BACKGROUND

1. Field

The present disclosure relates to methods and apparatuses for analyzing genetic data of subjects, and more particularly, to methods and apparatuses for analyzing genetic data acquired from an image analysis device such as a high contact cell imaging device, a high content screening device, or a high throughput screening device.

2. Description of the Related Art

‘Genome’ refers to the entirety of an organism's genetic information. There are various technologies for sequencing a person's genome, such as a DNA chip and next generation sequencing technology, and next-next-generation-sequencing technology. Genetic information, such as nucleic acid sequencing or protein information, is analyzed to find genes expressing diseases such as diabetes and cancer, or to examine the relationship between genetic diversity and genetic characteristics of individuals. In particular, a person's genetic information is important for examining different symptoms, or genetic characteristics of the person related to progress of a disease. Therefore, the genetic information is crucial for understanding current and future disease-related information to prevent diseases, and for selecting an optimal treatment at the initial stage of a disease.

High-dimensional data, such as data obtained from microarrays, is used in clinical studies to derive a biomarker candidate group and generate a statistical prediction model of clinical response variables using the biomarker candidate group. The microarrays data are widely used to examine a survival rate of patients, recurrence of diseases, metastasis or non-metastasis of diseases, drug response, etc. Recently, Affymetrix Gene-Chip™ became the first microarray to be approved by the U.S. Food and Drug Administration (FDA) as a clinical diagnosis test kit, and Illumina is to receive the U.S. FDA's approval for clinical sequencing devices and the like. This shows that clinical studies may be conducted more diversely using high-throughput technologies such as microarrays and the like in the future.

### SUMMARY

Provided are methods and apparatuses for analyzing genetic data of subjects.

Provided is a computer readable recording medium on which a program for executing the methods are recorded.

Additional aspects will be set forth in part in the description which follows and, in part, will be apparent from the description, or may be learned by practice of the presented embodiments.

According to an aspect of the present disclosure, a method of analyzing genetic data of a subject includes generating a plurality of bootstrap data sets having binary response variables related to a specific response, from the genetic data; determining a first bootstrap data set that represent the bootstrap data sets, based on distributions of the binary response variables; generating permutation null distributions by permutating the first bootstrap data set P (where P is a natural number) times; and calculating empirical power of the bootstrap data sets by testing respective levels of significance of the bootstrap data sets based on the permutation null distributions. The generating of the bootstrap data sets, the determining of the first bootstrap data set, the generating of the permutation null distributions, and the calculating of the empirical power are executed by at least one processor.

According to another aspect of the present disclosure, a non-transitory computer-readable recording medium having recorded thereon a program, which, when executed by a computer, performs the method of analyzing the genetic data of the subject.

According to another aspect of the present disclosure, a computing apparatus for analyzing genetic data of a subject includes a bootstrapping unit for generating a plurality of bootstrap data sets having binary response variables related to a specific response, from the genetic data; a determining unit for determining a first bootstrap data set that represents the bootstrap data sets, based on distributions of the binary response variables; a permutating unit for generating permutation null distributions by permutating the first bootstrap data set P (where P is a natural number) times; and a calculating unit for calculating empirical power of the bootstrap data sets by testing respective levels of significance of the bootstrap data sets based on the permutation null distributions.

### BRIEF DESCRIPTION OF THE DRAWINGS

These and/or other aspects will become apparent and more readily appreciated from the following description of the embodiments, taken in conjunction with the accompanying drawings in which:

FIG. 1 is a view of a genetic data analysis system according to an embodiment of the present disclosure;

FIG. 2A is a block diagram of a computing apparatus for analyzing genetic data;

FIG. 2B is a detailed block diagram of a processor according to an embodiment of the present disclosure;

FIG. 3 is a view of a relationship between genetic data, pilot data, and bootstrap data sets, according to an embodiment of the present disclosure;

FIG. 4 is a table of distribution of marginal-sums of binary response variables yᵢ^{simul} in 1,000 simulation bootstrap data sets \tilde{M}_{b}^{simul};

FIG. 5 is a view of a relationship between a first bootstrap data set and permutation data sets; and

FIG. 6 is a flowchart of a method of analyzing genetic data according to an embodiment of the present disclosure.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. Expressions such as “at least one of,” when preceding a list of elements, modify the entire list of elements and do not modify the individual elements of the list.

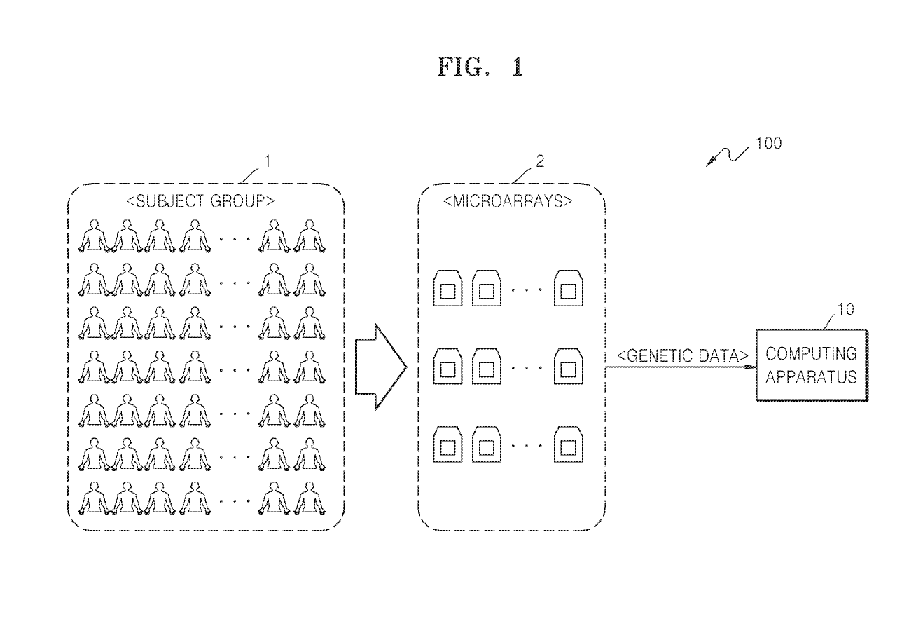

FIG. 1 is a view of a genetic data analysis system 100 according to an embodiment of the present disclosure. Referring to FIG. 1, the genetic data analysis system 100 includes a computing apparatus 10, and a plurality of microarrays 2 for acquiring genetic data of a subject group 1. The subject group 1 includes a group of people including patients having diseases, such as cancer, tumors, etc., or non-patients. Alternatively, the subject group 1 may include a group of test animals.

Although not shown in FIG. 1, one of ordinary skill in the art will understand that the genetic data analysis system 100 may additionally include an image analysis device such as a high contact cell imaging device, a high content screening device, or a high throughput screening device, for detecting gene expression patterns or gene expression levels from the subject group 1. Also, a polymerase chain reaction (PCR) apparatus may be used instead of the microarrays 2.

In order not to obscure features of the present embodiment, the genetic data analysis system 100 of FIG. 1 only shows elements that are related to the present embodiment. However, general elements other than the elements shown in FIG. 1 may be included in the genetic data analysis system 100.

Nucleic acid of an individual, such as deoxyribonucleic acid (DNA), is a genetic material including genetic information, i.e., genes. The base sequence of the nucleic acid includes information regarding cells, tissues, etc. that form the individual. Therefore, studies on nucleic acid sequence information of a person are performed to understand life phenomena, develop new drugs, diagnose and prevent diseases, conduct human genetic research, and the like.

A clinical specimen of the patient is used in biological studies. The clinical specimen, which is obtained by biopsy, endoscopy, surgery, and the like, may be used in pathological diagnosis, and then, if the patient approves, may be used for research. Accordingly, clinical specimens are highly valuable and scarce in most cases. Thus, it is important to estimate an appropriate sample size depending on an objective of research. When an experiment is conducted with too many samples, not only may the samples be wasted, but also it is likely that clinically useless results will be derived. On the contrary, when an experiment is conducted with too few samples, it is likely that scientifically meaningless results will be derived. Since a human body needs to be tested in the medical and clinical fields, it may be unethical to unnecessarily recruit too many people and test using unproven methods, or to test too few people and fail to yield scientifically meaningful conclusions. Therefore, when an Institutional Review Board (IRB) reviews a research proposal, it is important that the sample size is estimated with a statistical basis.

When it is intended to predict prognosis such as clinical response variables related to diseases, drug response, etc. using a biomarker, it is necessary to analyze genetic data such as microarray data. However, genetic data analysis processes typically require many calculation steps. In particular, among the genetic data analysis processes, a bootstrap data generation process and a permutation data generation process require a large amount of computing resources.

For example, a bootstrap data generation process and a permutation data generation process have been performed using genetic data introduced in Gene-expression Profiles Predict Survival of Patients with Lung Adenocarcinoma by Beer et al. (2002). Elapsed times of execution of the processes are shown in Table 1.

TABLE 1

| | | CPUs used | |
|---|---|---|---|
| Pieces of generated | Number of | for parallel | Elapsed time of |
| bootstrap data | permutation | calculation | execution |
| 1 | 1 | 8 | 22.27 sec |
| 1 | 1 | 12 | 16.2 sec |
| 1 | 1,000 | 12 | 71 min 32 sec |
| 100 | 100 | 1 | 9,084 min (6.3 days) |
| 100 | 100 | 12 | 757 min (12.6 h) |

When a single piece of bootstrap data is permutated 1,000 times, even if 12 central processing units (CPUs) are used for parallel calculation, an execution time is longer than 70 minutes. If 1,000 or more pieces of bootstrap data are generated when the genetic data is analyzed once, about 50 days (=70 min×1,000) are necessary. Therefore, if 1,000 pieces of permutation data are generated for each of the 1,000 or more pieces of bootstrap data, it will be impractical to analyze genetic data due to an excessively long execution time.

In the genetic data analysis system 100 according to the present embodiment, a method of reducing the time consumed during the numerous times permutation is performed is provided so as to reduce inefficiency due to the long execution time when analyzing the genetic data of the subject group 1 using the computing apparatus 10, as shown in Table 1. Hereinafter, operations and functions of the computing apparatus 10 according to the present embodiment will be described in detail.

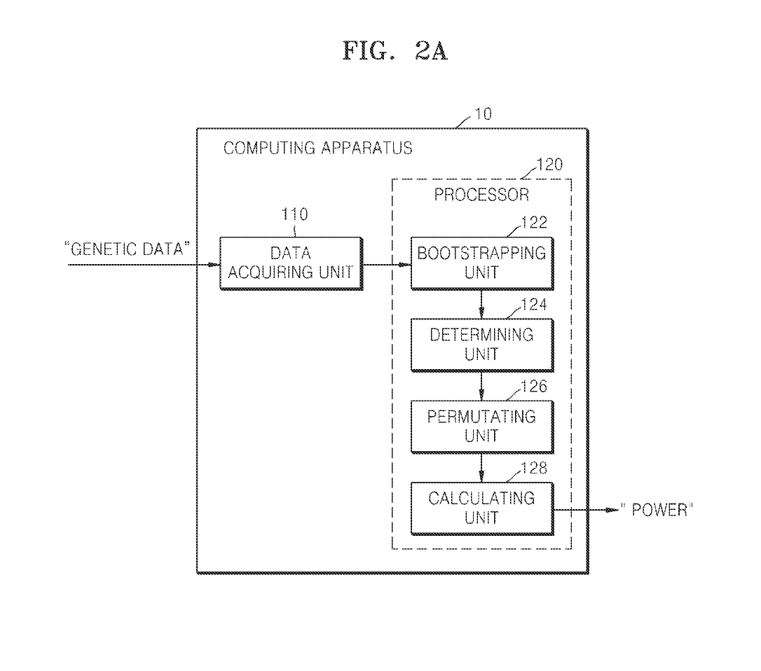

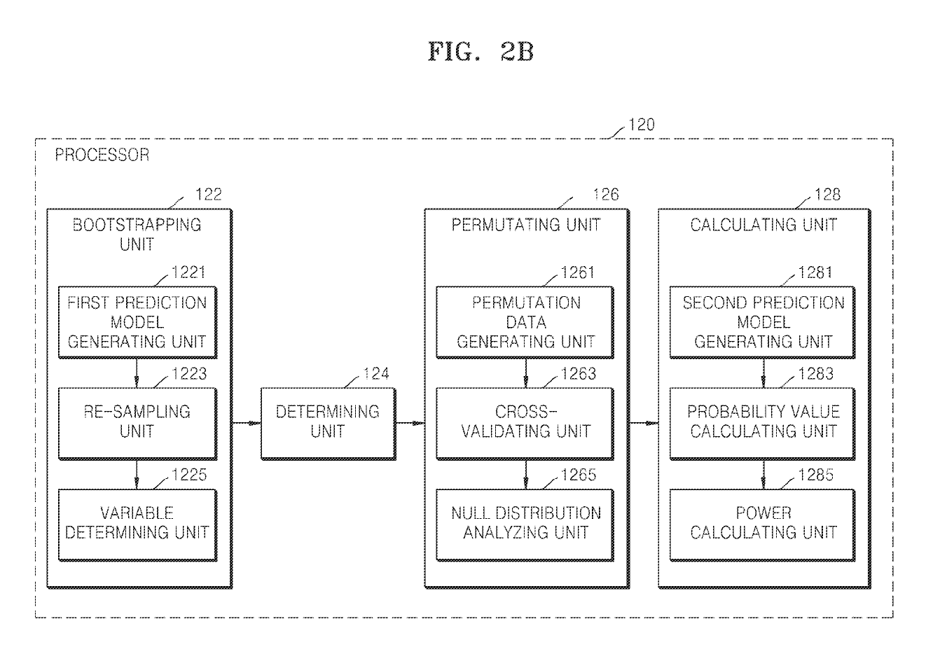

FIG. 2A is a block diagram of the computing apparatus 10 for analyzing the genetic data, according to an embodiment of the present disclosure.

Referring to FIG. 2A, the computing apparatus 10 includes a data acquiring unit 110, and a processor 120 that includes a bootstrapping unit 122, a determining unit 124, a permutating unit 126, and a calculating unit 128. The processor 120 may include one or more processors, and may be realized as a combination of an array of a plurality of logic gates, or a general use microprocessor and memory that stores a program that may be executed in the general use microprocessor. Alternatively, the processor 120 may be implemented as a module of an application program. Furthermore, one of ordinary skill in the art may understand that the computing apparatus 10 may be any type of hardware that may execute operations described in the present embodiments.

FIG. 2B is a detailed block diagram of the processor 120 according to an embodiment of the present disclosure.

Referring to FIG. 2B, as described above, the processor 120 includes the bootstrapping unit 122, the determining unit 124, the permutating unit 126, and the calculating unit 128. The bootstrapping unit 122 includes a first prediction model generating unit 1221, a re-sampling unit 1223, and a variable determining unit 1225. The permutating unit 126 includes a permutation data generating unit 1261, a cross-validating unit 1263, and a null distribution analyzing unit 1265. The calculating unit 128 includes a second prediction model generating unit 1281, a probability value calculating unit 1283, and a power calculating unit 1285.

Hereinafter, the operations and the functions of the computing apparatus 10 will be described with reference to FIGS. 2A and 2B. In order not to obscure features of the present embodiment, the computing apparatus 10 shown in FIGS. 2A and 2B only includes elements that are related to the present embodiment. However, general elements other than the elements shown in FIGS. 2A and 2B may be included in the computing apparatus 10.

The data acquiring unit 110 acquires the genetic data of the subject group 1. As described above, the genetic data includes detection results of gene expression patterns or gene expression levels, and corresponds to results of detecting genetic information of the subject group 1 that is acquired using an image analysis device such as a high contact cell imaging device, a high content screening device, or a high throughput screening device.

The data acquiring unit 110 may acquire the genetic data of the subject group 1 from the Gene Expression Omnibus (GEO) database of the National Center for Biotechnology Information (NCBI), or The Cancer Genome Atlas (TCGA) database of the National Cancer Institute (NCI) and National Human Genome Research Institute (NHGRI). Alternatively, the data acquiring unit 110 may acquire the genetic data from results that are acquired by directly conducting experiments on a microarray. That is, data may be acquired using any methods as long as a subject, an objective, and a platform of the research are not modified.

As shown in Table 2, the genetic data of the subject group 1 may be acquired, for example, as data of gene expression amounts of genes a, b, and c of subjects A, B, and C, but the present embodiment is not limited thereto.

TABLE 2

Binary Response Variables

| | | | |
|---|---|---|---|
| 0 | 1 | 1 | . . . |

Subject

| Gene | Subject A | Subject B | Subject C | . . . |
|---|---|---|---|---|
| Gene a | 0.00001 | 0.01433 | 0.01232 | . . . |
| Gene b | 0.00105 | 0.00133 | 0.00231 | . . . |
| Gene c | 0.00035 | 0.00022 | 0.00004 | . . . |
| . . . | . . . | . . . | . . . | . . . |

The first prediction model generating unit 1221 of the bootstrapping unit 122 pre-processes acquired genetic data before bootstrapping the genetic data of the subject group 1.

First, the bootstrapping unit 122 extracts some (e.g., of n number of people) genetic data as pilot data from among the genetic data of the subject group 1.

Pilot data M is defined by Equation 1 below, where n number of subjects each includes g number of genes, and xᵢⱼ is a gene expression amount of a j^{th} gene of an i^{th} subject.

M={(xᵢ₁, . . . , x_{ig}), i=1, . . . , n} [Equation 1]

The pilot data may include information regarding binary response variables that respectively correspond to the n number of subjects and are related to a specific condition or a specific response.

The specific condition or the specific response may be, for example, existence or non-existence of a tumor (cancer), lymph node metastasis +/−, or existence or non-existence of a drug effect, but is not limited thereto. The specific condition or the specific response may include various conditions or responses that may be used to determine +/− or existence or non-existence with respect to the provided data.

That is, the pilot data M may include gene expression data of the g number of genes of each of the n number of subjects, and the binary response variables that respectively correspond to the n number of subjects.

Binary response variables Yᵢ that respectively correspond to the n number of subjects may be defined by Equation 2 below.

$${y}_{i} = \{ \begin{matrix}0 , & if {i}^{th} subject is normal \\ 1 , & if {i}^{th} subject has an event\end{matrix} \qquad [ Equation 2 ]$$

For example, in a drug response experiment, it may be assumed that a subject having a binary response variable of 0 is in a control group, and a subject having a binary response variable of 1 is in a treatment group. Alternatively, in a lymph node metastasis experiment, it may be assumed that a subject having a binary response variable of 0 corresponds to lymph node metastasis −, and a subject having a binary response variable of 1 corresponds to lymph node metastasis +. Alternatively, regarding a tumor, it may be assumed that a subject having a binary response variable of 0 is normal, and a subject having a binary response variable of 1 is in a tumor group. However, the present embodiment is not limited to the examples above.

The first prediction model generating unit 1221 generates a prediction model for predicting the binary response variables y₁ in the pilot data, using the pilot data as in Equation 1. The prediction model may be generated using a logistic regression model. However, the present embodiment is not limited thereto, and the prediction model may be generated using other types of models or algorithms.

First, the first prediction model generating unit 1221 generates a prediction model using a univariate logistic regression model which uses each gene included in the pilot data as a single variable.

The first prediction model generating unit 1221 may use the univariate logistic regression model by normalizing the pilot data as in Equation 3 below.

$${X}_{ij}^{′} = \frac{{X}_{ij} - {\overline{X}}_{j}}{{S}_{j}} \\ where {\overline{X}}_{j} = {\sum }_{i = 1}^{n} {X}_{ij} / n , \\ {S}_{j} = \sqrt{{\sum }_{i = 1}^{n} {( {X}_{ij} - {\overline{X}}_{j} )}^{2} / ( n - 1 )} \qquad [ Equation 3 ]$$

Referring to Equation 3, X̅ⱼ is an average of gene expression amounts of the j^{th} gene, and Sⱼ is a standard deviation of the gene expression amounts of the j^{th} gene.

The first prediction model generating unit 1221 uses a generated univariate logistic regression model to calculate an effect size \hat{β}ⱼ and a probability value, which are obtained by testing the null hypothesis H₀:βⱼ=0, or each of the genes included in the pilot data.

The first prediction model generating unit 1221 uses respective p-values of the genes to determine a top t number of genes. The top t number of genes that are determined by the first prediction model generating unit 1221 may be genes that are greatly influential in determining whether the binary response variable is 0 or 1. Among the g number of genes, how many genes are to be determined as the top t number of genes by the first prediction model generating unit 1221 may vary according to the use environment of the genetic data analysis system 100 of the present embodiment.

The first prediction model generating unit 1221 generates a multivariate logistic regression model which determines the determined top t number of genes as independent variables. The multivariate logistic regression model will be described with reference to Equation 4 below.

$$log it ( {p}_{i} ) = log ( \frac{{p}_{i}}{1 - {p}_{i}} ) = {\hat{β}}_{0} + {\hat{β}}_{1} {X}_{i 1}^{′} + ⋯ + {\hat{β}}_{t} {X}_{it}^{′} \qquad [ Equation 4 ]$$

Equation 4 is a multivariate logistic regression model for an i^{th} patient, which is generated using the pilot data. Referring to Equation 4, \hat{β}=(\hat{β}₀, \hat{β}₁, . . . , \hat{β}ₜ) indicates coefficients of the multivariate logistic regression model of the top t number of genes, and X′=(X′₁, . . . , X′ₜ) indicates normalized gene expression amounts that correspond to the top t number of genes.

The coefficients \hat{β}=(\hat{β}₀, \hat{β}₁, . . . , \hat{β}ₜ) of the multivariate logistic regression model of the pilot data are used to determine binary response variables which will be included in bootstrap data sets to be described below.

When the first prediction model generating unit 1221 has finished generating the multivariate logistic regression model of the pilot data as in Equation 4, the bootstrapping unit 122 bootstraps the pilot data.

The re-sampling unit 1223 generates bootstrap gene expression data having N (where N is a natural number) number of samples using statistical properties of the pilot data and gene expression amounts that are extracted from the pilot data.

With respect to the pilot data M as defined in Equation 1, the re-sampling unit 1223 calculates a sample mean X̅ⱼ and a standard deviation Sⱼ of the genes j=(1, . . . , g).

As in Equation 5 below, the re-sampling unit 1223 generates a bootstrap data set \tilde{M} having N (where N>n) number of samples with respect to probability variables of εᵢ, . . . , ε_{N}˜iidN(0,1).

$$\tilde{M} = \{ ( {z}_{i 1} , ⋯ , {z}_{ig} ) , i = 1 , ⋯ , N \} \\ where \frac{{z}_{ij} = ( {x}_{{i}^{′} j} - \overline{{x}_{j}} )}{{s}_{j}} , \qquad [ Equation 5 ]$$

i′ is randomly chosen number from (1, . . . , n)

When the pilot data M is given, conditional covariance of a bootstrap data set \tilde{M} is approximately equal to covariance of the pilot data M, which may be defined by Equation 6 below.

cov(\tilde{M}|M)→cov(M), as n→∞ [Equation 6]

Following the processes described above, the re-sampling unit 1223 generates the bootstrap data set \tilde{M} using the pilot data M. However, the re-sampling unit 1223 only generates bootstrap gene expression data to be included in the bootstrap data set \tilde{M}, and the variable determining unit 1225 determines binary response variables to be included in the bootstrap data set \tilde{M}.

The variable determining unit 1225 determines the binary response variables in the bootstrap gene expression data using the bootstrap gene expression data \tilde{M} that is generated by the re-sampling unit 1223.

The variable determining unit 1225 calculates a risk score of the N number of samples included in the bootstrap data set \tilde{M} using the prediction model of the pilot data described with reference to Equation 4. The risk score of the N number of samples included in the bootstrap data set \tilde{M} may be calculated as in Equation 7 below.

$$\begin{matrix}{\hat{p}}_{i} = P ( {y}_{i} = 1 \vert z ) \\ = \frac{1}{1 + exp \{ - ( {\hat{β}}_{0} + {\hat{β}}_{1} {z}_{i 1} + ⋯ + {\hat{β}}_{t} {z}_{i t} ) \}}\end{matrix} \qquad [ Equation 7 ]$$

Referring to Equation 7, \hat{β}=(\hat{β}₀, \hat{β}₁, . . . , \hat{β}ₜ) indicates the coefficients of the multivariate logistic regression model of the pilot data.

The variable determining unit 1225 calculates binary response variables y′ᵢ(i=1, . . . , N) that respectively correspond to the N number of samples in the bootstrap data set \tilde{M} using Bernoulli trials with probability \hat{p}ᵢ as in Equation 8 below.

y′ᵢ˜Bernoulli (\hat{p}ᵢ) [Equation 8]

As shown in Equation 9 below, the bootstrapping unit 122 generates b^{th} bootstrap data set \hat{M}_{b} that includes the bootstrap gene expression data \hat{M}={(zᵢ₁, . . . , z_{ig}), i=1, . . . , N} generated by the re-sampling unit 1223, and the binary response variables y′ᵢ(i=1, . . . , N) determined by the variable determining unit 1225.

\tilde{M}_{b}={y′ᵢ, (zᵢ₁, . . . , z_{ig})} [Equation 9]

where i=(1, . . . , N), b=(1, . . . , B)

While the description above is about a case where the bootstrapping unit 122 performs a bootstrapping process once, Equation 9 describes a case where the bootstrapping unit 122 repeats the bootstrapping process B times to thus generate B number of bootstrap data sets \tilde{M}_{b}(b=1, . . . , B) that are different from each other.

The variable determining unit 1225 of the bootstrapping unit 122 generates the bootstrap data sets such that marginal-sums of the binary response variables y′ᵢ(i=1, . . . , N) in each of the B number of bootstrap data sets \tilde{M}_{b}(b=1, . . . , B) are the same.

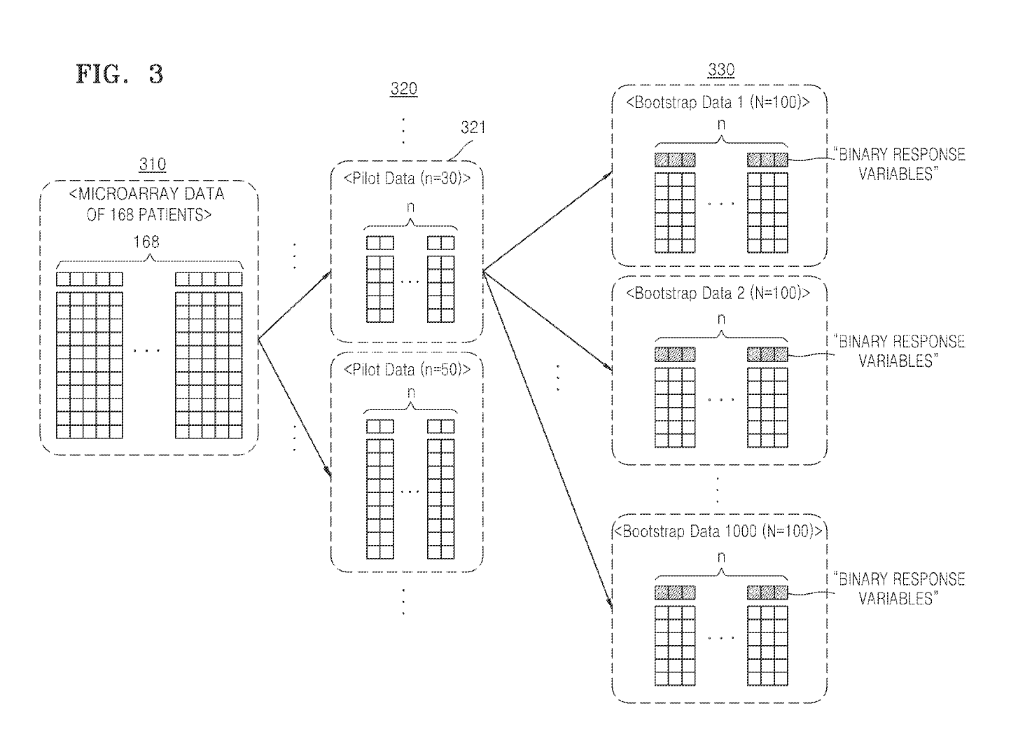

FIG. 3 is a view of a relationship between genetic data 310, pilot data 320, and bootstrap data sets 330 according to an embodiment of the present disclosure.

Referring to FIG. 3, it is assumed that there is the genetic data 310 of 168 patients, which is acquired by the data acquiring unit 110.

The bootstrapping unit 122 randomly extracts some among the genetic data 310 to generate the pilot data 320. The pilot data 320 may be data of various numbers of patients, for example, data of 30 patients (n=30) or data of 50 patients (n=50).

In a case where the pilot data 320 of 30 patients (n=30) is used, the bootstrapping unit 122 may use the pilot data 320 to generate B (e.g., B=1000) number of bootstrap data sets 330 having N (e.g., N=100) number of samples.

The bootstrap data sets 330 may each include data of predicted binary response variables y′ᵢ(i=1, . . . , N).

Since FIG. 3 is only provided to generally describe the relationship between the genetic data 310, the pilot data 320, and the bootstrap data sets 330, numerical values in FIG. 3 are random values.

Referring back to FIG. 2B, from the B number of bootstrap data sets \tilde{M}_{b}(b=1, . . . , B) generated by the bootstrapping unit 122, the determining unit 124 determines a first bootstrap data set \tilde{M}_{b}, that represents the entire bootstrap data set \tilde{M}, based on distribution of the binary response variables y′ᵢ(i=1, . . . , N).

Specifically, among the B number of bootstrap data sets \tilde{M}_{b}(b=1, . . . , B), the determining unit 124 determines a bootstrap data set that includes binary response variables y′ᵢ that are distributed with the highest frequency as the first bootstrap data set \tilde{M}_{b′}.

As described above, the variable determining unit 1225 of the bootstrapping unit 122 generates the bootstrap data sets such that the marginal-sums of the binary response variables y′ᵢ(i=1, . . . , N) in each of the B number of bootstrap data sets \tilde{M}_{b}(b=1, . . . , B) are the same.

Hereinafter, the reason why the bootstrap data set that includes binary response variables y′ᵢ that are distributed with the highest frequency is determined as the first bootstrap data set \tilde{M}_{b′} is described.

For example, in a multivariate normal distribution (MVN) (0,Σ), where the average is 0 and there are 100 genes, simulation of genetic data having N number of samples is defined by Equation 10 below.

M^{simul}={(zᵢ₁, . . . , zᵢ₁₀₀), i=1, . . . , N} [Equation 10]

As defined in Equation 11 below, a covariance matrix is a block-diagonal matrix having a size of g x g, in which a size of a block corresponds to a 10×10 autocorrelation structure.

$$Σ = {( \begin{matrix}{Σ}_{ρ} & 0 & ⋯ & ⋯ & ⋯ & ⋮ \\ 0 & {Σ}_{ρ} & 0 & ⋱ & ⋱ & ⋮ \\ ⋮ & 0 & {Σ}_{ρ} & 0 & ⋱ & ⋮ \\ ⋮ & ⋱ & 0 & {Σ}_{ρ} & 0 & ⋮ \\ ⋮ & ⋱ & ⋱ & 0 & {Σ}_{ρ} & ⋮ \\ ⋯ & ⋯ & ⋯ & ⋯ & ⋯ & ⋯\end{matrix} )}_{100 \times 100} \\ {Σ}_{ρ} = {( \begin{matrix}1 & ρ & ⋯ & {ρ}^{8} & {ρ}^{9} \\ ρ & 1 & ⋱ & ⋮ & {ρ}^{8} \\ ⋮ & ⋱ & ⋱ & ⋱ & ⋮ \\ {ρ}^{8} & ⋯ & ⋱ & 1 & ρ \\ {ρ}^{9} & {ρ}^{8} & ⋯ & ρ & 1\end{matrix} )}_{10 \times 10} \qquad [ Equation 11 ]$$

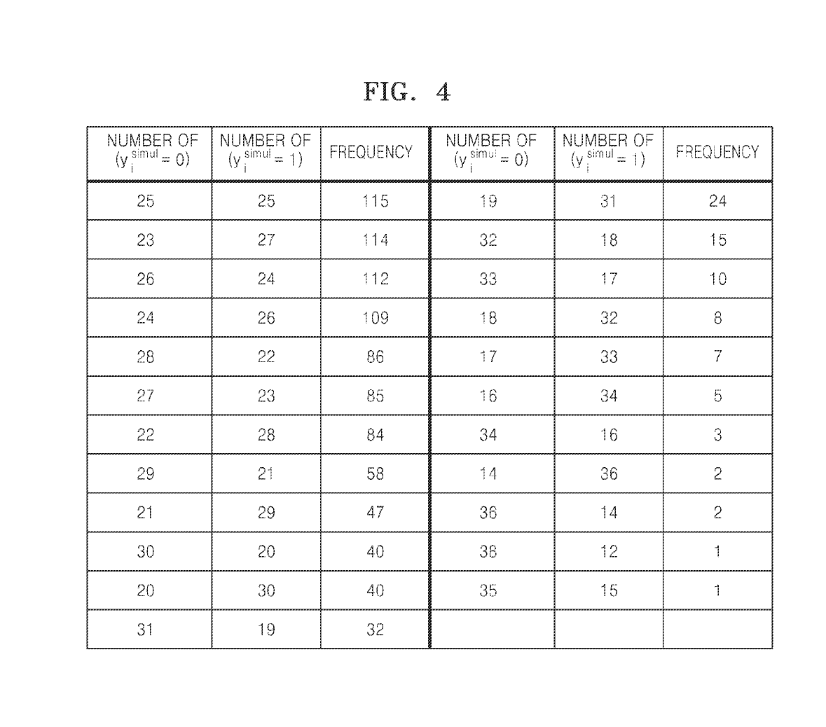

In the simulation genetic data M^{simul} defined as in Equations 10 and 11, 1,000 simulation bootstrap data sets \tilde{M}_{b}^{simul}={yᵢ^{simul}, (zᵢ₁, . . . , zᵢ₁₀₀); i=1, . . . , N}, b=1, . . . , 1000, where n=30, p=100, ρ=0.5, N=50, and an effective size of the genes are β=0, may be generated. In this case, marginal-sums of binary response variables yᵢ^{simul} of the 1,000 simulation bootstrap data sets \tilde{M}_{b}^{simul} may be distributed as shown in FIG. 4.

FIG. 4 is a table of distributions of the marginal-sums of the binary response variables yᵢ^{simul} of the 1,000 simulation bootstrap data sets \tilde{M}_{b}^{simul}.

Referring to FIG. 4, among the 1,000 simulation bootstrap data sets \tilde{M}_{b}^{simul}, there are 115 simulation bootstrap sets, in which there are 25 cases where the binary response variable yᵢ^{simul} is 0 and 25 cases where the binary response variable yᵢ^{simul} is 1, and accordingly, this simulation bootstrap set has the highest frequency. However, a distribution of the binary response variables yᵢ^{simul} shown in FIG. 4 is only a result that is randomly acquired by simulation, and thus, the present embodiment is not limited thereto.

Since the effective size of the genes is β=0 in the 1,000 simulation bootstrap data sets \tilde{M}_{b}^{simul}, a probability of Bernoulli trials for determining the binary response variable is defined as pᵢ=½. Therefore, among the simulation bootstrap data sets \tilde{M}_{b}^{simul}, a case that has the highest frequency is where there is a similar number of 0's and 1's among the 50 binary response variables yᵢ^{simul}.

After calculating a maximum likelihood estimator (MLE) of a non-centrality parameter (NCP) of a non-central χ² distribution for each of the simulation bootstrap data sets \tilde{M}_{b}^{simul}, a histogram of 1,000 NCPs shows normal distribution. Also, in comparison to cumulative density functions (CDFs) of permutation null distributions of the simulation bootstrap data sets \tilde{M}_{b}^{simul}, a CDF of the non-central χ² distribution having an average of the NCP of each of the simulation bootstrap data sets \tilde{M}_{b}^{simul} passes the center of 1,000 permutation null distributions.

Accordingly, it may be assumed that, among the simulation bootstrap data sets \tilde{M}_{b}^{simul}, a simulated bootstrap data set that includes binary response variables that are distributed with the highest frequency (for example, 115, as in FIG. 4) represents all of the simulated bootstrap data sets \tilde{M}_{b}^{simul}.

Referring back to FIG. 2B, among the B number of bootstrap data sets \tilde{M}_{b}(b=1, . . . , B) that are generated by the bootstrapping unit 122, the determining unit 124 determines the first bootstrap data set \tilde{M}_{b′} having the highest frequency of the marginal-sums of the binary response variables y′ᵢ.

The permutating unit 126 generates permutation null distributions by permutating the first bootstrap data set \tilde{M}_{b′}, which is determined by the determining unit 124, P (where P is a natural number) times.

Specifically, the permutation data generating unit 1261 generates P number of permutation data sets by permutating the first bootstrap data set \tilde{M}_{b′}. High dimension data such as genetic data may be permutated by fixing data of gene expression amounts in the first bootstrap data set \tilde{M}_{b′}, and then arbitrarily matching binary response variables with the data of gene expression amounts. Even when performing the permutation process as described above, respective marginal-sums of the P number of permutation data sets that are generated from the first bootstrap data set \tilde{M}_{b′} are the same.

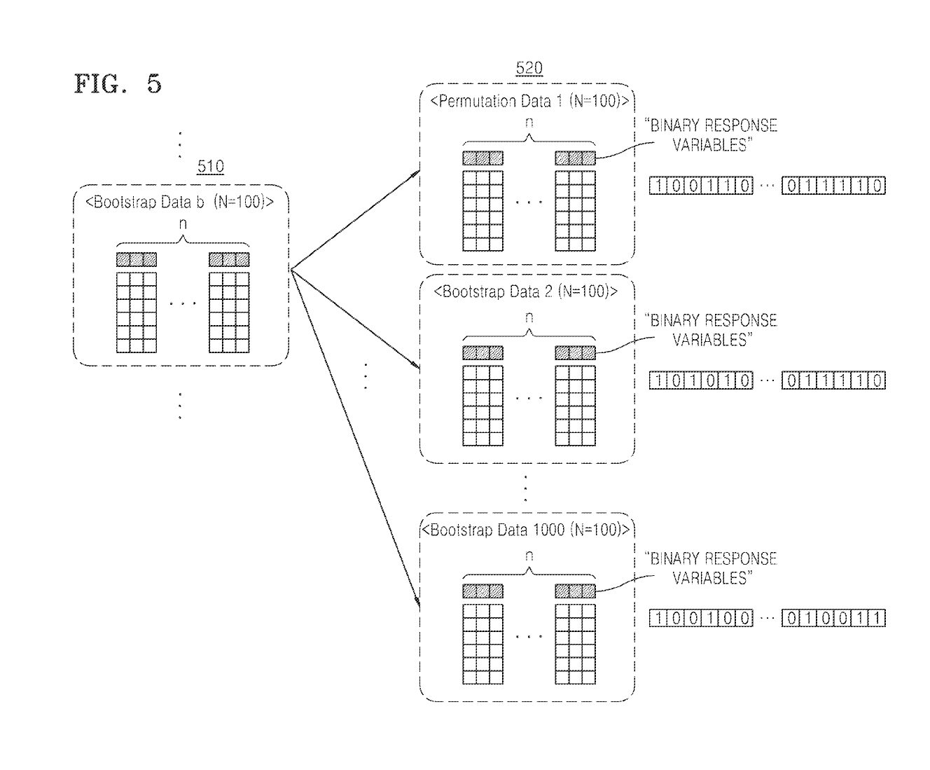

FIG. 5 is a view of a relationship between a first bootstrap data set 510 and permutation data sets 520.

Referring to FIG. 5, the permutation data generating unit 1261 generates P (e.g., P=1,000) number of permutation data sets 520 from the first bootstrap data set 510 that is determined by the determining unit 124.

As described above, each of the permutation data sets 520 includes the same data of gene expression amounts. However, even when marginal-sums of binary response variables included in the permutation data sets 520 are the same, binary response variables that are included in each of the 1,000 permutation data sets 520 may be distributed as in FIG. 4.

Referring back to FIG. 2B, the cross-validating unit 1263 performs k-fold cross-validation on each of the P number of permutation data sets 520.

The k-fold cross-validation is performed by randomly classifying the P number of permutation data sets 520 into k-fold sets having approximately the same number of pieces of data, and then, using k-1 number of sets as training sets and the single remaining set as a testing set. The k-fold cross-validation is a method in which the above-described process is repeated k times to evaluate a prediction model that is formed in the training sets with respect to the testing set.

In the related art, when the k-fold cross-validation is performed, a data set may be repeatedly used as a training set or a testing set, and thus, a prediction model may be overfit.

In particular, when the k-fold cross-validation is performed on the bootstrap data sets \tilde{M} during a process of analyzing the genetic data, a bootstrap data set may be repeatedly used as a training set or a testing set and thus be overfit. In this regard, variation of test statistics of the bootstrap data sets \tilde{M} may be relatively large, or validity of a prediction model may be evaluated as being unstable.

In order to solve this problem, permutation may need to be performed. However, as described above, an excessively large amount of time may be required to generate the bootstrap data sets \tilde{M}, and permutation data sets for each of the bootstrap data sets \tilde{M}.

Instead of permutating the entire bootstrap data set \tilde{M}, the computing apparatus 10 according to the present embodiment permutates a single first bootstrap data set \tilde{M}_{b′} that represents the entire bootstrap data set \tilde{M}. Therefore, less amount of computing resources may be required, and it is possible to obtain an analysis result that is similar to an analysis result obtained by permutating the entire bootstrap data set \tilde{M}.

The null distribution analyzing unit 1265 performs a chi-square test to a result of k-fold cross-validation and calculates chi-square (χ²) statistics, and thus acquires permutation null distributions {χ_{b′p}²: p=1, . . . , P} of the first bootstrap data set \tilde{M}_{b′}.

Since the first bootstrap data set \tilde{M}_{b′} represents the entire bootstrap data set \tilde{M}, the permutation null distributions {χ_{b′p}²: p=1, . . . , P} of the first bootstrap data set \tilde{M}_{b′} are regarded as respective permutation null distributions of the remaining bootstrap data sets excluding the first bootstrap data set \tilde{M}_{b′}.

The calculating unit 128 calculates empirical power of the bootstrap data sets \tilde{M} by testing respective levels of significance of the bootstrap data sets \tilde{M} based on the permutation null distributions {χ_{b′p}²: p=1, . . . , P}.

Specifically, the second prediction model generating unit 1281 generates prediction models that respectively correspond to the bootstrap data sets \tilde{M} generated by the bootstrapping unit 122. Similar to the pilot data, the second prediction model generating unit 1281 generates a prediction model that corresponds to the b^{th} bootstrap data set \tilde{M}_{b} using a univariate logistic regression model and a multivariate logistic regression model. In this case, the prediction model may be for predicting the binary response variables y′ᵢ using gene expression amounts of N number of samples included in the b^{th} bootstrap data set \tilde{M}_{b}.

The probability value calculating unit 1283 may use various methods to calculate probability values that represent validity of the prediction models that respectively correspond to the bootstrap data sets \tilde{M}.

According to a first method, the probability value calculating unit 1283 calculates respective probability values p_{b} of the B number of bootstrap data sets \tilde{M}_{b}(b=1, . . . , B) according to a distribution rate of chi-square test statistics χₚ² of the P number of permutation data sets that are greater than a chi-square test statistic χ_{b}² of the b^{th} bootstrap data set \tilde{M}_{b}. That is, the probability value calculating unit 1283 may use Equation 12 below to calculate the probability value p_{b}.

$${p}_{b} = {P}^{- 1} {\sum }_{p = 1}^{P} I ( {χ}_{b}^{2} \leq {χ}_{p}^{2} ) \\ where b = 1 , ⋯ , B \qquad [ Equation 12 ]$$

According to a second method, the probability value calculating unit 1283 calculates the respective probability values p_{b} of the B number of bootstrap data sets \tilde{M}_{b}(b=1, . . . , B) that correspond to a NCP, by fitting the chi-square test statistics χₚ² of the P number of permutation data sets to the non-central χ² distribution.

Specifically, a CDF of the non-central χ² distribution has a probability density function (PDF) as in Equation 13 below.

$${f}_{X} ( x ; k , λ ) = {\sum }_{i = 0}^{∞} \frac{{{e}^{- λ / 2} ( λ / 2 )}^{i}}{i !} g ( x ; k + 2 i ) , \qquad [ Equation 13 ]$$

where g(x; v) is a PDF of central χ² distribution,
k is a degree of freedom(df), and λ is a non-centrality parameter

Afterward, the probability value calculating unit 1283 may estimate a NCP \hat{λ}ₘₗₑ using a maximum likelihood estimation that uses the permutation null distributions {χ_{b′p}²: p=1, . . . , P} of the first bootstrap data set \tilde{M}_{b′}, and thus calculate the probability value p_{b} as in Equation 14 below.

p_{b}=1−F_{X}(χ_{b}²; k=1, \hat{λ}ₘₗₑ), [Equation 14]

where Fₓ is CDF of f_{X}.

According to a third method, the probability value calculating unit 1283 calculates the respective probability values p_{b} of the B number of bootstrap data sets \tilde{M}_{b}(b=1, . . . , B) by approximately calculating an estimated probability value (p_{b}) of permutation performed P times according to an estimated probability value (pₑ) of permutation performed an infinite number of times.

Specifically, when the estimated probability value (pₑ) of permutation performed an infinite number of times is a true value, pₑ is approximately calculated by performing permutation 1,000 times. The true value pₑ may be defined by Equation 15 below, where D is the number of p-values that have extreme values during permutation performed P times.

$${p}_{e} = Pr ( D \leq d ) , where D = {\sum }_{p = 1}^{P} I ( {p}_{b} \geq {p}_{p} ) \qquad [ Equation 15 ]$$

Pₜ is the number of cases where all possible permutations have different statistics, and Dₜ is the number of cases where statistics have extreme values. A relationship between Pₜ and Dₜ is defined by Equation 16 below.

pₜ=Pr(Dₜ≦dₜ) [Equation16]

When \hat{p}=Dₜ/Pₜ in Equation 16, Dₜ follows a binary distribution where the number of trials is Pₜ and a probability for each trial is p_{∞}, as in Equation 17 below.

Dₜ=\hat{p}·Pₜ˜B(Pₜ, p_{∞}), [Equation 17]

where p_{∞}=Pr(χₚ²≧χ_{b}²)

A probability that Dₜ may have a specific value dₜ is defined by Equation 18 below.

$$\begin{matrix}Pr ( {D}_{t} = {d}_{t} ) = {\int }_{0}^{1} Pr ( {D}_{t} = {d}_{t} , {p}_{∞} ) d {p}_{∞} \\ = {\int }_{0}^{1} Pr ( {D}_{t} = {d}_{t} \vert {p}_{∞} ) f ( {p}_{∞} ) d {p}_{∞} \\ = {\int }_{0}^{1} ( \begin{matrix}{P}_{t} \\ {d}_{t}\end{matrix} ) {{p}_{∞}^{{d}_{t}} ( 1 - {p}_{∞} )}^{{P}_{t} - {d}_{t}} d {p}_{∞} \\ = \frac{{P}_{t} !}{( {P}_{t} - {d}_{t} ) ! {d}_{t} !} \times \frac{{d}_{t} ! ( {P}_{t} - {d}_{t} ) !}{( {d}_{t} + 1 + {P}_{t} - {d}_{t} + 1 - 1 ) !} \\ = \frac{1}{{P}_{t} + 1}\end{matrix} \qquad [ Equation 18 ]$$

Equation 18 indicates that a random variable Dₜ follows a discrete uniform distribution. Therefore, Equation 16 may be written as in Equation 19 below.

$$Pr ( {D}_{t} \leq {d}_{t} ) = \frac{{d}_{t} + 1}{{P}_{t} + 1} = {p}_{t} \qquad [ Equation 19 ]$$

Referring to Equation 19, when Dₜ=dₜ, a distribution of D is P times of independent trials in which a probability of an extreme value each time permutation is performed equals pₜ. Thus, the distribution of D follows a binary distribution as in Equation 20 below.

D|(Dₜ=dₜ)˜B(P, pₜ) [Equation 20]

pₑ may be acquired using Equation 20 and Equation 21 below.

$$\begin{matrix}{p}_{e} = Pr ( D \leq d \vert {H}_{0} ) \\ = {\sum }_{{d}_{t} = 0}^{{P}_{t}} Pr ( D \leq d , {D}_{t} = {d}_{t} \vert {H}_{0} ) \\ = {\sum }_{{d}_{t} = 0}^{{P}_{t}} Pr ( D \leq d \vert {D}_{t} = {d}_{t} ) Pr ( {D}_{t} = {d}_{t} ) \\ = \frac{1}{{P}_{t} + 1} {\sum }_{{d}_{t} = 0}^{{P}_{t}} F ( d ; P , {p}_{t} ) ,\end{matrix} \\ where P ( {P}_{t} = {d}_{t} \vert {H}_{0} ) = \frac{1}{{P}_{t} + 1} , \\ P ( D \leq d \vert {D}_{t} = {d}_{t} ) = F ( d ; P , {p}_{t} ) \qquad [ Equation 21 ]$$

Based on pₑ that is calculated using a cumulative distribution F, the respective probability values P_{b} of the B number of bootstrap data sets \tilde{M}_{b} (b=1, . . . , B) may be calcuated as in Equation 22 below, which uses an integral approximation method.

$$\begin{matrix}{p}_{e} \approx {\int }_{0.5 / ( {P}_{t} + 1 )}^{1} F ( d ; P , {p}_{t} ) d {p}_{t} \\ = {\int }_{0}^{1} F ( d ; P , {p}_{t} ) d {p}_{t} - {\int }_{1}^{0.5 / ( {P}_{t} + 1 )} F ( d ; P , {p}_{t} ) d {p}_{t} \\ = \frac{d + 1}{P + 1} - {\int }_{1}^{0.5 / ( {P}_{t} + 1 )} F ( d ; P , {p}_{t} ) d {p}_{t} \\ = {p}_{b}\end{matrix} \qquad [ Equation 22 ]$$

Specifically, according to the third method, the probability value calculating unit 1283 may calculate the probability value p_{b} of permutation performed P times using the estimated probability value (pₑ) of permutation performed an infinite number of times.

The power calculating unit 1285 tests respective levels of significance of the respective probability values p_{b} of the B number of bootstrap data sets \tilde{M}(b=1, . . . , B) based on the permutation null distributions generated from the first bootstrap data set \tilde{M}_{b′}, and then calculates a distribution rate of bootstrap data sets that are determined to be valid among the B number of bootstrap data sets \tilde{M}_{b}(b=1, . . . , B).

Specifically, first, the power calculating unit 1285 generates an empirical distribution according to the permutation null distributions generated from the first bootstrap data set \tilde{M}_{b′}. Then, the power calculating unit 1285 compares the respective probability values p_{b} of the B number of bootstrap data sets \tilde{M}_{b}(b=1, . . . , B) to a predetermined level of significance α (for example, 5%) in the empirical distribution so as to test whether or not the b^{th} bootstrap data set \tilde{M}_{b} is valid.

For example, the power calculating unit 1285 may determine that the b^{th} bootstrap data set \tilde{M}_{b} is valid when a calculated probability value p_{b} is equal to or less than the predetermined level of significance α, and is invalid when the calculated probability value p_{b} is greater than the predetermined level of significance α.

The power calculating unit 1285 calculates empirical power of sample size N by calculating a distribution rate of bootstrap data sets that are determined to be valid based on the predetermined level of significance α among the B number of bootstrap data sets \tilde{M}_{b}(b=1, . . . , B). The predetermined level of significance α may vary.

Accordingly, the power calculating unit 1285 may calculate empirical power (1−\hat{β}_{N}), which is a test result of the sample size N, using Equation 23.

$$( 1 - {\hat{β}}_{N} ) = \frac{1}{B} {\sum }_{b = 1}^{B} I ( {p}_{b} < α ) \qquad [ Equation 23 ]$$

According to Equation 23, under the assumption that a target power (1−β) is 0.80, when the empirical power (1−\hat{β}_{N}) of the sample size N exceeds 0.80, it is determined that the sample size N corresponds to an optimal sample size Nₒₚₜ for performing an experiment or research related to a specific response or a specific condition. However, when the empirical power (1−\hat{β}_{N}) of the sample size N is equal to or lower than 0.80, it is determined that the sample size N does not correspond to an optimal sample size Nₒₚₜ.

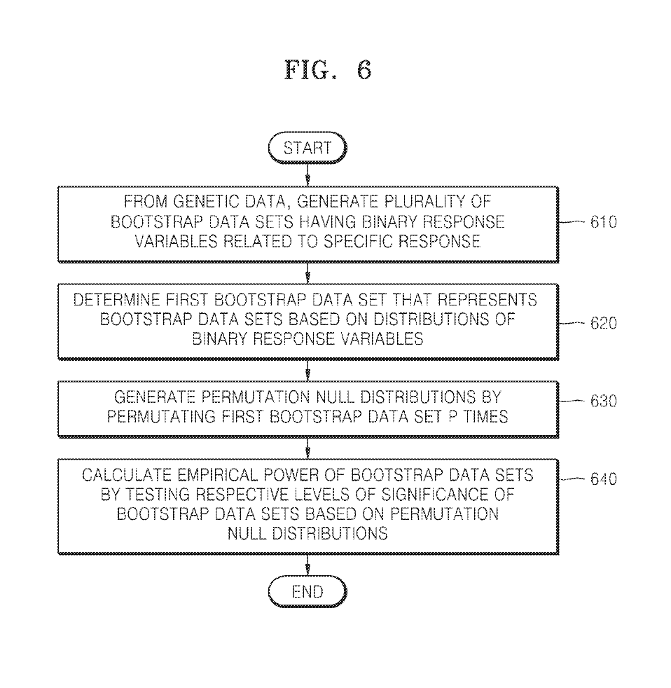

FIG. 6 is a flowchart of a method of analyzing the genetic data according to an embodiment of the present disclosure. Referring to FIG. 6, the method of analyzing the genetic data according to the present embodiment includes operations that are time-sequentially processed by the computing apparatus 10 shown in FIGS. 2A and 2B. Therefore, all of the above-described elements and features shown in the previous drawings may be included in the method of analyzing the genetic data according to the present embodiment.

In operation 610, the bootstrapping unit 122 generates the plurality of bootstrap data sets \tilde{M} having the binary response variables y′ᵢ related to a specific response, from the genetic data.

In operation 620, the determining unit 124 determines the first bootstrap data set \tilde{M}_{b′} that represents the bootstrap data sets \tilde{M}, based on distributions of the binary response variables y′ᵢ.

In operation 630, the permutating unit 126 generates the permutation null distributions {χ_{b′p}²: p=1, . . . , P} by permutating the first bootstrap data set \tilde{M}_{b′} P (where P is a natural number) times.

In operation 640, the calculating unit 128 calculates the empirical power of the bootstrap data sets \tilde{M} by testing the respective levels of significance of the bootstrap data sets \tilde{M} based on the permutation null distributions.

In general, statistical analysis methods that generate a plurality of permutation data sets so as to cross-validate a plurality of bootstrap data sets consume an excessively large amount of computing resources and have a long execution time. However, according to the above-described embodiments of the present disclosure, a plurality of permutation data sets that are generated from a single bootstrap data set representing the entire bootstrap data sets may be used to more quickly acquire an approximate result. Thus, it is possible to reasonably reduce a consumption amount of computing resources and the execution time.

In addition, other embodiments of the present disclosure can also be implemented through computer readable code/instructions in/on a medium, e.g., a computer readable medium, to control at least one processing element to implement any of the above described embodiments. The medium can correspond to any medium/media permitting the storage and/or transmission of the computer readable code.

The computer readable code can be recorded/transferred on a medium in a variety of ways, with examples of the medium including non-transitory recording media, such as magnetic storage media (e.g., ROM, floppy disks, hard disks, etc.) and optical recording media (e.g., CD-ROMs, or DVDs), and transmission media such as Internet transmission media. Thus, the medium may be such a defined and measurable structure including or carrying a signal or information, such as a device carrying a bitstream according to one or more embodiments of the present disclosure. The media may also be a distributed network, so that the computer readable code may be stored/transferred and executed in a distributed fashion. Furthermore, the processing element may include a processor or a computer processor, and processing elements may be distributed and/or included in a single device.

It should be understood that the exemplary embodiments described herein should be considered in a descriptive sense only and not for purposes of limitation. Descriptions of features or aspects within each embodiment should typically be considered as available for other similar features or aspects in other embodiments.

While one or more embodiments of the present disclosure have been described with reference to the figures, it will be understood by those of ordinary skill in the art that various changes in form and details may be made therein without departing from the spirit and scope of the present disclosure as defined by the following claims.

What is claimed is:

1. A processor-implemented method of analyzing genetic data of a subject, the method comprising:
generating a plurality of bootstrap data sets having binary response variables related to a specific response, from the genetic data;
determining a first bootstrap data set that represents the bootstrap data sets, based on distributions of the binary response variables;
generating permutation null distributions by permutating the first bootstrap data set P times, where P is a natural number; and
calculating an empirical power of the bootstrap data sets by testing respective levels of significance of the bootstrap data sets based on the permutation null distributions,
wherein the generating of the bootstrap data sets, the determining of the first bootstrap data set, the generating of the permutation null distributions, and the calculating of the empirical power are executed by at least one processor.

2. The method of claim 1, wherein the determining of the first bootstrap data set comprises determining, as the first bootstrap data set, a bootstrap data set that includes binary response variables that are distributed with a highest frequency.

3. The method of claim 1, wherein the generating of the bootstrap data sets comprises generating the bootstrap data sets such that marginal-sums of the binary response variables in each of the bootstrap data sets are the same.

4. The method of claim 1, wherein the permutation null distributions are respective permutation null distributions of the remaining bootstrap data sets excluding the first bootstrap data set.

5. The method of claim 1, wherein the generating of the permuation null distributions comprises:
generating P permutation data sets by permutating the first bootstrap data set;
performing k-fold cross-validation on each of the P permutation data sets; and
performing a chi-square test on a result of the k-fold cross-validation so as to acquire permutation null distributions of the first bootstrap data set,
wherein the permutation null distributions are generated based on the acquired permutation null distributions.

6. The method of claim 1, wherein the calculating of the empirical power comprises:
generating prediction models that respectively correspond to the bootstrap data sets;
calculating probability values that represent validity of the prediction models; and
testing respective levels of significance of respective probability values of the prediction models based on the permutation null distributions, and calculating a distribution rate of bootstrap data sets that are determined to be valid among the bootstrap data sets,
wherein the empirical power is calculated based on the distribution rate.

7. The method of claim 6, wherein respective probability values of B bootstrap data sets are calculated according to a distribution rate of chi-square test statistics of P permutation data sets that are generated by permutation and are greater than a chi-square test statistic of a b^{th} bootstrap data set, where B is a natural number and where b is a natural number that is equal to or less than B.

8. The method of claim 6, wherein respective probability values of B bootstrap data sets that correspond to a non-centrality parameter are calculated by fitting chi-square test statistics of P permutation data sets, which are generated by permutation, to a non-central chi-square distribution, where B is a natural number.

9. The method of claim 6, wherein respective probability values of B bootstrap data sets are calculated by calculating an estimated probability value of permutation performed P times according to an estimated probability value of permutation performed an infinite number of times, where B is a natural number.

10. The method of claim 6, wherein the empirical power is a test result of a sample size N of the bootstrap data sets, where N is a natural number.

11. A non-transitory computer-readable recording medium having recorded thereon a program, which, when executed by a computer, causes the computer to perform the method of claim 1.

12. A computing apparatus for analyzing genetic data of a subject, the computing apparatus comprising:
a bootstrapping unit that generates a plurality of bootstrap data sets having binary response variables related to a specific response, from the genetic data;
a determining unit that determines a first bootstrap data set that represents the bootstrap data sets, based on distributions of the binary response variables;
a permutating unit that generates permutation null distributions by permutating the first bootstrap data set P times, where P is a natural number; and
a calculating unit that calculates empirical power of the bootstrap data sets by testing respective levels of significance of the bootstrap data sets based on the permutation null distributions.

13. The computing apparatus of claim 12, wherein the determining unit determines as the first bootstrap data set a bootstrap data set that includes binary response variables that are distributed with the highest frequency.

14. The computing apparatus of claim 12, wherein the bootstrapping unit generates the bootstrap data sets such that marginal-sums of the binary response variables in each of the bootstrap data sets are the same.

15. The computing apparatus of claim 12, wherein the permutation null distributions are respective permutation null distributions of the remaining bootstrap data sets excluding the first bootstrap data set.

16. The computing apparatus of claim 12, wherein the permutating unit comprises:
a permutation data generating unit that generates P permutation data sets by permutating the first bootstrap data set;
a cross-validating unit that performs k-fold cross-validation on each of the P permutation data sets; and
a null distribution analyzing unit that performs a chi-square test on a result of the k-fold cross-validation so as to acquire permutation null distributions of the first bootstrap data set,
wherein the permutation null distributions are generated based on the acquired permutation null distributions.

17. The computing apparatus of claim 12, wherein the calculating unit comprises:
a prediction model generating unit that generates prediction models that respectively correspond to the bootstrap data sets;
a probability value calculating unit that calculates probability values that represent validity of the prediction models; and
a power calculating unit that tests respective levels of significance of respective probability values of the prediction models based on the permutation null distributions, and calculates a distribution rate of bootstrap data sets that are determined to be valid among the bootstrap data sets,
wherein the empirical power is calculated based on the distribution rate.

18. The computing apparatus of claim 17, wherein the probability calculating unit calculates respective probability values of B (where B is a natural number) number of bootstrap data sets according to a distribution rate of chi-square test statistics of P number of permutation data sets that are generated by permutation and are greater than a chi-square test statistic of a b^{th} (where b is a natural number that is equal to or less than B) bootstrap data set.

19. The computing apparatus of claim 17, wherein the probability value calculating unit calculates respective probability values of B bootstrap data sets that correspond to a non-centrality parameter by fitting chi-square test statistics of P permutation data sets, which are generated by permutation, to a non-central chi-square distribution, where B is a natural number.

20. The computing apparatus of claim 17, wherein the probability value calculating unit calculates respective probability values of B bootstrap data sets by calculating an estimated probability value of permutation performed P times according to an estimated probability value of permutation performed an infinite number of times, where B is a natural number.
